(19) United States
(12) Patent Application Publication
(10) Pub. No.: US 2008/0276068 A1
(43) Pub. Date: Nov. 6, 2008

(54) IMS network architecture with integrated network elements

(76) Inventors: Syed Reaz Ashraf, Sparta, NJ (US); Behzad Davachi Mottahed, Montclair, NJ (US)

Correspondence Address: MCCORMICK, PAULDING & HUBER LLP, 185 ASYLUM STREET, CITY PLACE II, HARTFORD, CT, 06103, US

(21) Appl. No.: 11/799,944

(22) Filed: May 3, 2007

(51) Int. Cl. G06F 15/00; G06F 3/00

(52) U.S. Cl. 712/20; 710/1

(57) ABSTRACT

An IP multimedia subsystem (IMS) network includes (i) a plurality of network elements that are directly or indirectly interconnected for carrying out communications and (ii) an integrated IMS network control unit interfaced with the other network elements. The control unit integrates three IMS network functions into one network node: a multimedia resource function (MRF) module, which incorporates a multimedia resource function controller (MRFC) and/or one or more multimedia resource function processors (MRFP), e.g., media servers; a media gateway control function (MGCF); and a media gateway (MGW). The external physical interface of the control unit mimics the typical interfaces of the MRF/MRFC, MGCF, and MGW, were they to be provided as separate network elements/nodes. As such, the control unit is both physically and logically transparent to the rest of the network, as relating to the integrated MRF, MGCF, and MGW functions.

### FIELD OF THE INVENTION

The present invention relates to communication systems and, more particularly, to network elements in an IMS telecommunication network.

### BACKGROUND OF THE INVENTION

The IP Multimedia Subsystem (“IMS”) is a standardized “next generation” networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of SIP (session initiation protocol). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

One example of an IMS-based network 10 is shown in simplified form in FIG. 1. Here, the IMS control architecture includes a home subscriber server (“HSS”) 12 and a call session control function (“CSCF”) 14, and may generally be divided into a services/application layer 16a, an IMS layer 16b, and a transport layer 16c. The HSS 12 is the central repository of all subscriber-specific authorizations and service profiles and preferences. The HSS 12 integrates several functions/elements, some of which may exist already (for example, in the home location register of wireless networks), including subscriber/user profile database, subscriber service permissions, authentication and authorization, subscriber preference settings, mobile authentication server, and the like. An SLF 18 (subscriber location function) is needed when multiple HSS's are used. The CSCF 14 carries out the primary SIP signaling functions in the network. The CSCF 14 includes several types of SIP servers, including a proxy-CSCF server (the first point of contact for device and controls authentication), an interrogating-CSCF server (the entry point of all SIP messages), and a serving-CSCF server, which manages session control functions. Additionally, application servers 20 host and execute services, and interface with the CSCF 14 using SIP. This allows third party providers to easily integrate and deploy their value added services on the IMS infrastructure. Examples of services include caller ID related services, call waiting, call holding, push to talk, conference call servers, voicemail, instant messaging, call blocking, and call forwarding. A circuit-switched (“CS”) network gateway 22 interfaces the IMS 10 with circuit-switched networks 24 such as a public switched telephone network (“PSTN”). The gateway 22 may include a BGCF (breakout gateway control function), which is an SIP server that includes routing functionality based on telephone numbers, an SGW (signaling gateway) that interfaces with the signaling plane of the network 24, an MGCF (media gateway controller function) for call control protocol conversion, and an MGW (media gateway) that interfaces with the media plane of the circuit-switched network 24. An MRF 26 (media resource function) may be provided as a media source in the network, e.g., for multimedia conferencing, text-to-speech conversation and speech recognition, and real-time transcoding of multimedia data, e.g., conversion between different codecs.

At the transport layer 16c, the IMS layer 16b is connected to a core broadband IP network 28, possibly through the MRF 26 and/or an IMS gateway 30. The IMS gateway 30 may include an IMS application layer gateway 32 (“IMS-ALG”) and a translation gateway 34 (“TrGW”) for facilitating communications with networks using different versions of the Internet protocol, e.g., IPv4 and IPv6. The core IP network 28 is also connected to one or more external IP packet data networks (“IP PDN”) 36, e.g., the Internet, and to other networks such as a DSL or other wire-line network 38, wireless local area networks (“WLAN”) 40, and wireless networks 42. Typically, one or more intermediate network elements are used for facilitating these connections, such as a WLAN access gateway (“WAG”) and/or WLAN packet data gateway (“PDG”) 44, a serving GPRS support node (“SGSN”) 46 and gateway GPRS service node (“GGSN”) 48, and a digital subscriber line access multiplexer (“DSLAM”) and broadband access server (“BAS”) 50. (In the case of 3GPP2 implementation, there would typically be a home agent “HA” instead of the GGSN 48, and a packet data serving node “PDSN” instead of the SGSN 46.) The SGSN 46 is responsible for mobility management and IP packet session management. It routes user packet traffic from the radio network 42 to the appropriate GGSN 48, providing access to external packet data networks, in this case the core network 28. The DSLAM 50 is a network device, usually located at a telephone company central office, or within a neighborhood serving area interface as part of a digital loop carrier, that receives signals from multiple customer DSL connections and aggregates the signals on a high-speed backbone line using multiplexing techniques. In this case, the DSLAM 50 connects the DSL network 38 with the core IP network 28.

The networks 38, 40, 42 may be functionally/logically connected to the CSCF 14 through various control/functional elements. For example, the IMS system may include a policy decision function (“PDF”) 52, which enables the access network to be managed using dynamic policies. Additional functional elements 54 (grouped together for simplicity of illustration) may include a service policy decision function (“SPDF”), an access-resource and admission control function (“A-RACF”), and a network attachment subsystem (“NASS”). The SPDF, for example, makes policy decisions using policy rules and forwards session and media related information, obtained from an application function, to the A-RACF for admission control purposes. The A-RACF is a functional element that performs resource reservation admission control and network policy assembly functions. For simplicity of illustration, some intermediate network elements such as access gateways and server nodes are not shown. Further explanation regarding the operation of an IMS network is available in the literature, and is known to those skilled in the art.

In an IMS-based network, as is generally the case with other communication networks, user terminals 56a, 56b provide a means for users to communicate with one another over the network(s). Each terminal is an electronic device with hardware and/or software-based functionality for communicating over a network, and typically including user input/output means such as a keyboard and display. Examples include computers and wireless units such as mobile phones and wireless PDA's. When one terminal 56a initiates communication with another terminal 56b, various signaling procedures are automatically carried out by the network, according to the network's communication protocols, for opening a communication channel between the two terminals.

As should be apparent from FIG. 1, the IMS network architecture includes a large number of network elements. Accordingly, IMS networks can be expensive to implement and operate in terms of capital outlay and maintenance and upkeep costs. Moreover, the network elements have to be interconnected and interfaced together for proper functioning of the IMS network, which results in significant development costs and high levels of network operational expenditures. Because of these factors and a corresponding perceived sense of over-complexity, network operators and service providers may be disinclined to implement IMS networks or add IMS network functionality to existing systems.

### SUMMARY OF THE INVENTION

An embodiment of the present invention relates to an IMS (IP multimedia subsystem) network architecture with integrated network elements. The IMS network includes a number of IMS network elements, which are interconnected for implementing communications over the network. (By “network element,” it is meant telecommunications equipment, typically comprising a combination of hardware and software, that is addressable and manageable, and that primarily performs a core telecommunications service function of the IMS network.) An integrated IMS network control unit is interfaced with the other network elements. The control unit is a single network node, and includes a multimedia resource function controller (“MRFC”) module, a media gateway control function (“MGCF”) module, and a media gateway (“MGW”) module all integrated into the single network node of the control unit. “Module” refers to processing functionality implemented in hardware and/or software. Also, by “network node,” it is generally meant a grouping of one or more network elements at one site/location, which provides network-related functions, and which is administered as a single entity. In another, more specific embodiment, the single network node of the control unit is embodied as the MRFC, MGCF, and MGW modules being housed together in a chassis portion of the control unit.

The MRFC, MGCF, and MGW modules conform to the IMS network's specifications for MRFC, MGCF, and MGW signal processing functionality. Thus, although integrated into a single network node, the modules provide the same IMS network functions as separate-node MRFC, MGCF, and MGW units.

In a more general sense, the integrated IMS network control unit may be characterized as including a multimedia resource function (“MRF”) module, which incorporates a MRFC and/or one or more multimedia resource function processors (“MRFP”).

As indicated above, in one embodiment, the integrated IMS network control unit includes a chassis, e.g., a housing, cabinet, case, framework, or the like. The MRFC, MGCF, and MGW modules are housed together in the chassis along with an external physical interface. The physical interface includes one or more terminals, connectors, ports, plugs, or the like for physically and electrically connecting the integrated modules to one or more data cables or other signal buses of the IMS network, which are in turn directly or indirectly connected to the other network elements. The external physical interface conforms to a specification of the IMS network for MGCF, MRFC, and MGW physical interfaces. Thus, the control unit is physically and electrically connected to the IMS network in the same manner as if the MRFC, MGCF, and MGW modules were implemented as separate network nodes, meaning that the control unit is transparent to the IMS network bus architecture in terms of its integrated configuration.

In another embodiment, the integrated IMS network control unit includes an internal bus that interconnects the MRFC, MGCF, and MGW modules. This allows the modules to exchange information internally, which may be required for carrying out MRFC, MGCF, and MGW IMS functions.

In another embodiment, the control unit includes an input/output (I/O) controller that controls the transfer of data between the external physical interface and the MRFC, MGCF, and MGW modules, in conjunction with an internal bus if one is provided. The I/O controller directs data received at the external physical interface to the modules, based on the content of the data and/or on where the data is received at the physical interface. The I/O controller is used in situations where data signals from different sources may be present at the same physical interface or on the same bus or other electrical pathway. For example, if the control unit includes a common internal bus interconnecting the modules with the external physical interface, the I/O controller ensures that data signals arriving at the external physical interface are transferred to the modules for which they are intended. Transfer may be based on the content of the data (e.g., address information or the like), or upon where the data arrives at the physical interface, if the physical interface includes dedicated sub-portions. For example, the physical interface may include a dedicated MRFC connector(s), a dedicated MGCF connector, and a dedicated MGW connector. Data arriving at each connector is transferred to its respective module. (If the control unit utilizes dedicated signal pathways between the external physical interface and each module, a separate I/O controller is typically not required.) The I/O controller and internal bus may be an integrated unit, e.g., a bus scheduler or controller.

An embodiment of the present invention also relates to a system and method for exchanging data in an IMS network. According to the method, data is transferred between a plurality of IMS network elements and a single node of the IMS network. (The single node is interfaced with the plurality of IMS network elements for communicating over the IMS network.) The single node includes a multimedia resource function controller (MRFC) module, a media gateway control function (MGCF) module, and a media gateway (MGW) module. The modules are integrated together, e.g., as an integrated IMS network control unit as described above, and conform to the IMS network's specifications for performing MRFC, MGCF, and MGW functions.

### BRIEF DESCRIPTION OF THE DRAWINGS

The present invention will be better understood from reading the following description of non-limiting embodiments, with reference to the attached drawings, wherein below:

FIG. 1 is a schematic diagram of an IMS (IP multimedia subsystem) network according to the prior art;

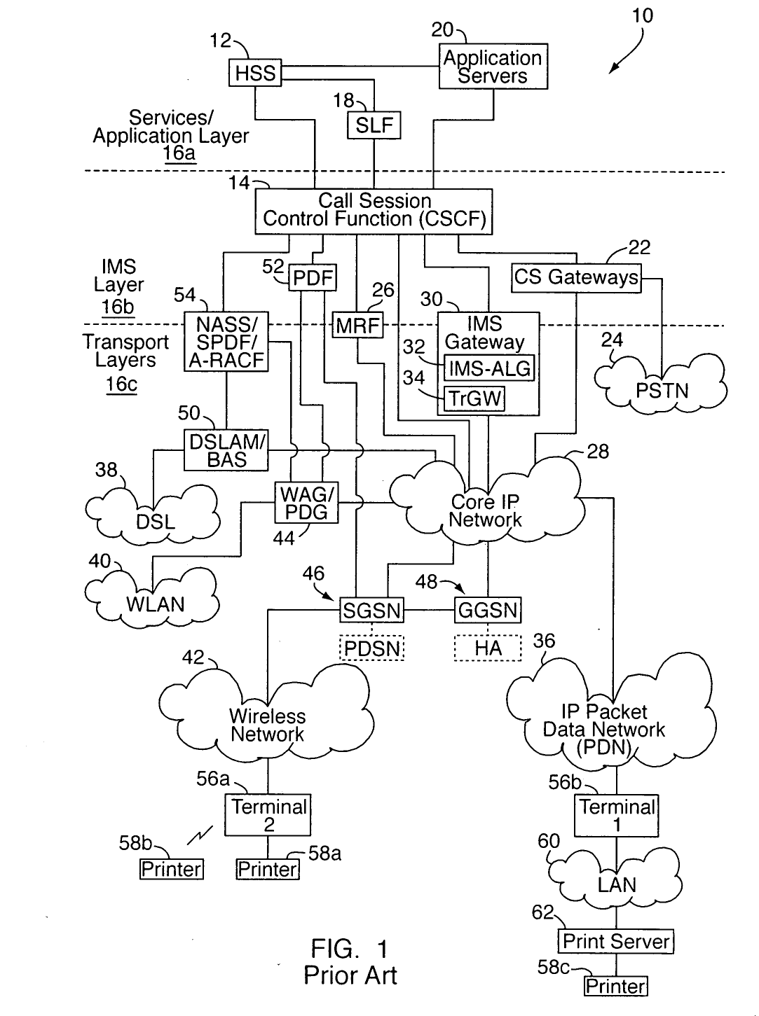

FIGS. 2 and 3 are schematic diagrams of an IMS network architecture with integrated network elements, according to an embodiment of the present invention;

FIGS. 4 and 5 are detail views of alternative embodiments of an integrated IMS network control unit portion of the IMS network architecture; and

FIGS. 6A and 6B are schematic diagrams of alternative embodiments of an external physical interface portion of the integrated IMS network control unit.

### DETAILED DESCRIPTION

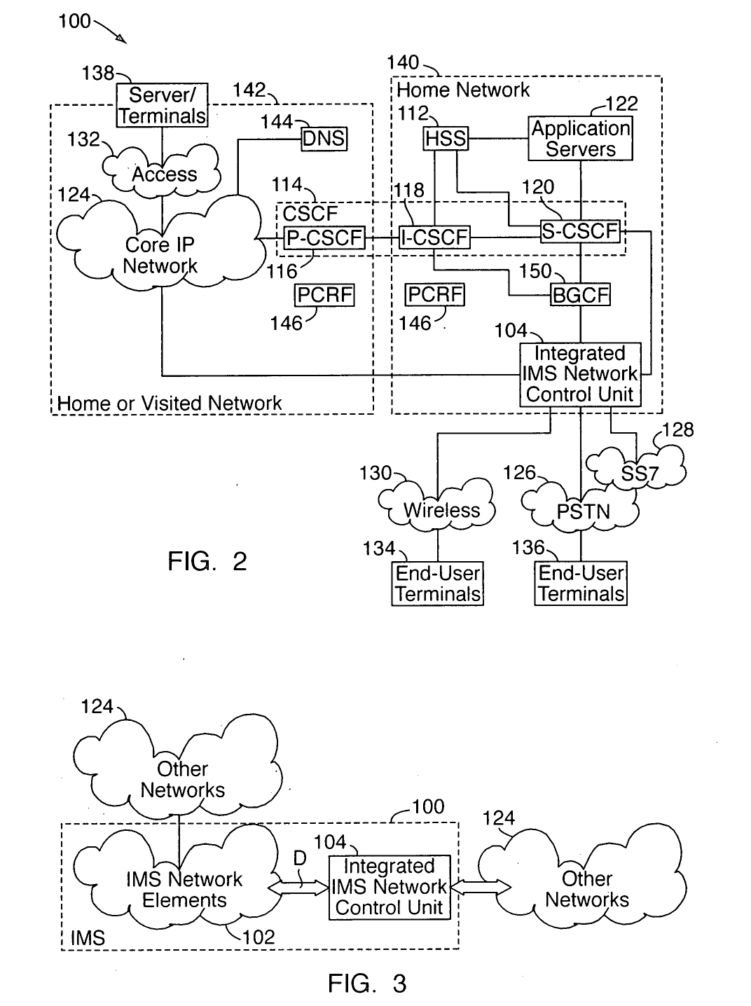

With reference to FIGS. 2-6B, an IMS (IP multimedia subsystem) network architecture with integrated networks elements 100 includes a plurality of network elements 102 that are interconnected for implementing communications over the IMS network. As noted above, “network element” refers to telecommunications equipment, typically comprising a combination of hardware and software, that is addressable and manageable, and that primarily performs a core telecommunications service function of the IMS network. An integrated IMS network control unit 104 is interfaced with the other network elements 102, either directly or indirectly. The control unit 104 is a single network node, and includes a multimedia resource function controller (MRFC) module 106, a media gateway control function (MGCF) module 108, and a media gateway (MGW) module 110, all of which are integrated together into the single network node of the control unit 104. By “network node,” it is generally meant a grouping of one or more network elements at one site/location, which provides network-related functions, and which is administered as a single entity. In another, more specific embodiment, the network node is embodied as a single chassis that houses the MRFC, MGCF, and MGW modules. “Module” refers to processing functionality implemented in hardware and/or software.

The control unit 104 (with its integrated MRFC module 106, MGCF module 108, and MGW module 110) conforms to the IMS network's specifications for stand-alone MRFC, MGCF, and MGW units, both in terms of their external physical interfaces and signal/data processing functionality. Thus, although integrated into a single network node, the modules 106, 108, 110 provide the same IMS network functions/interfaces as separate-node MRFC, MGCF, and MGW units. Accordingly, operation of the integrated IMS network control unit 104 is transparent to the rest of the IMS network, as relating to its integrated configuration.

With reference to FIG. 3, operation of the integrated control unit 104 may be characterized as implementing a method for exchanging data in an IMS network 100. According to the method, data “D” is transferred between a plurality of IMS network elements 102 and a single node 104 of the IMS network. The single node 104 includes a multimedia resource function controller (MRFC) module, a media gateway control function (MGCF) module, and a media gateway (MGW) module. The modules are integrated together, e.g., as an integrated IMS network control unit as described above, and conform to the IMS network's specifications for performing MRFC, MGCF, and MGW functions.

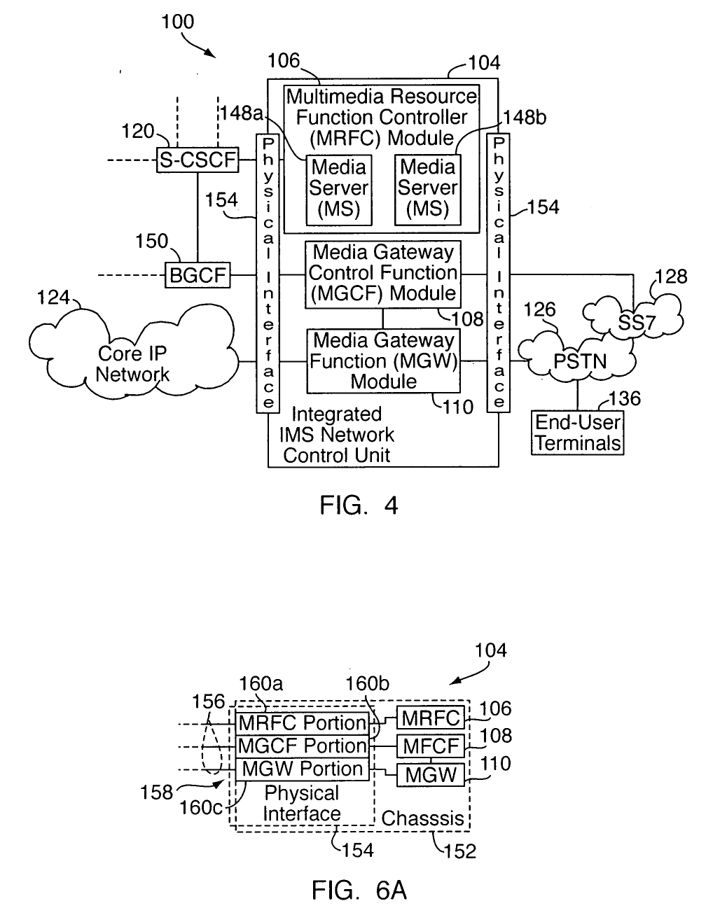

FIG. 2 shows the relationship of the control unit 104 to the rest of the IMS network, while FIG. 4 shows the integrated component portions of the control unit 104 and how they specifically interact with the other network elements.

To explain further, as the term is used herein according to its customary and normal meaning, “IMS network” refers to an IP multimedia and telephony core network as generally defined by 3GPP and 3GPP2 standards and organizations based on IETF Internet protocols. Generally speaking, the elements of the IMS network architecture 100 (apart from the integrated control unit 104) are configured in a standard manner according to the aforementioned standards and protocols. Thus, the IMS network 100 includes an HSS (home subscriber server) 112 and a call session control function (“CSCF”) 114. The HSS 112 is the central repository/database of all subscriber- or user-specific data, including user authorizations, service permissions, service profiles, and preferences. The HSS 112 integrates several functions/elements, including authentication and authorization, mobile authentication server, and the like. The CSCF 114 carries out the primary SIP signaling functions in the network 100. The CSCF 114 includes several types of SIP servers, including a proxy-CSCF (“P-CSCF”) server 116 (which is the first point of contact for device and controls authentication and routes communications to the I-CSCF), an interrogating-CSCF (“I-CSCF”) server 118 (which is the entry point of all SIP messages), and a serving-CSCF (“S-CSCF”) server 120, which manages session control functions. Application servers 122 host and execute services, and interface with the CSCF 114 using SIP. This allows third party providers to easily integrate and deploy their value added services on the IMS infrastructure. Examples include caller ID-related services, call waiting, call holding, push to talk, conference call servers, voicemail, instant messaging, call blocking, and call forwarding.

The CSCF 114 is connected to a broadband IP network 124, which acts as the core of the IMS network 100 for interconnecting the IMS network elements with one another and with other networks 124. Thus, the IMS network 100 may include and/or be connected with a number of IP-based and other networks such as the Internet, DSL networks, public switched telephone networks (“PSTN”) 126 and other wire-line networks (e.g., SS7-based networks 128), wireless networks 130 such as those using CDMA, GSM, IEEE 802.11x, and/or UMTS communications or the like, and local area networks. Typically, the IMS core network 124 is interfaced with other networks 124 by way of a gateway or other access point 132, including the control unit 104. (In other words, in addition to other functions, the control unit 104 acts as a gateway between the IMS network and, e.g., the PSTN 126, as explained in more detail below.)

For communicating over the IMS network 100, end-user subscribers are provided with end-user communication terminals 134, 136, 138. The terminals 134, 136, 138 are electronic devices capable of communicating with one another over the network(s) 100, 124, 126, 128, 130, and may include, for example, computer terminals, wire-line connected communication devices such as conventional telephones and enhanced/multimedia-capable telephones 136, and/or wireless units 134 such as mobile phones, wireless PDA's, wireless devices with high-speed data transfer capabilities, such as those compliant with “3-G” or “4-G” standards, “WiFi”-equipped computer terminals, and the like. The terminals communicate with one another over the networks in a standard manner, depending on the particular networks used and the particular type of terminals. For example, in the case of wireless units 134 and a wireless network 130, the network 130 may include one or more fixed base stations (not shown) having various transceivers and antennae for wireless, radio-frequency (RF) communications with the wireless units over one or more RF channels, in a manner based on the wireless communication method and protocol used.

As indicated in FIG. 2, some of the network elements (such as the I-CSCF 118 and S-CSCF 120) will typically be located in a “home” portion 140 of the network. Other elements (e.g., the P-CSCF) may be located in the home portion or in a “visited” network portion 142. The designations “home” and “visited” are based on the perspective of the terminals communicating over the IMS network. Thus, the home network portion 140 is the logically- or physically-local portion of the network to which the terminal initiating communications is linked. The visited portion is determined by whether the communication pathway in question extends beyond the home portion, based on the network location of the receiving communication terminal.

Other IMS network elements illustrated in FIG. 2 include domain name servers 144 and policy and charging rules function (“PCRF”) elements 146. For simplicity of illustration, additional intermediate network elements (such as access gateways and server nodes) are not shown. Further explanation regarding the operation of an IMS network is available in the literature, and is known to those skilled in the art.

As discussed above, and with reference to FIG. 4, the integrated IMS network control unit 104 includes an MRFC module 106, an MGCF module 108, and an MGW module 110, all of which are integrated together into the single network node of the control unit 104. The MRFC module 106 provides media server capabilities, and implements a control function for controlling a plurality of multimedia resource function processors 148a, 148b, which are referred to herein as “media servers” 148a, 148b. Each media server 148a, 148b is a device configured for storing and sharing media over the IMS network (e.g., using SIP), such as video, audio, multimedia content, and the like, and for implementing related services (alone or in conjunction with other network elements) such as announcement services, interactive voice response, audio and video conferencing and streaming, web content integration, and the like. Typically, the MRFC module 106 is connected to the S-CSCF 120, and communicates therewith according to SIP.

Certain IMS networks are more generally characterized as having a multimedia resource function (“MRF”), which incorporates the MRFC and/or multimedia resource function processors. As used herein, “MRF” module therefore refers to a hardware/software unit implementing media processing-related functions in an IMS network and including MRFC functionality and/or one or more multimedia resource function processors (e.g., media servers).

The MGCF module 108 provides a media gateway control (MGC) function for VoIP purposes, thereby providing the centralized call control function for multiple network gateways. Additionally, the MGCF module 108 acts as a bridge between third generation converged multi-service networks and legacy circuit switched networks. For example, the MGCF module 108 may carry out the call processing functions necessary to translate between SIP-based wireline or wireless calls in the IMS network and ISUP calls in a PSTN 126. (In other words, the MGCF module converts SIP to ISUP, for interfacing the IMS network with a PSTN, other SS7-based network, or other legacy network.) The MGCF module 108 is connected to a breakout gateway control function (“BGCF”) 150 and to the PSTN 126, SS7-based network 128, or other external network. The BGCF 150 is an SIP server that includes routing functionality based on telephone numbers. In particular, the BGCF 150 selects the network in which PSTN breakout is to occur. For example, if the breakout is to occur in the same network as the BGCF 150, then the BGCF 150 selects the MGCF module 108, which is responsible for interworking with the PSTN 126. The MGCF then receives the SIP signaling from the BGCF 150. The MGCF module 108 is also connected to the MGW module 110 in the integrated control unit 104, and serves as the central node for the MGW module 110, performing the conversion of circuit-switched signaling and call control protocols to SIP and vice versa. It also controls and manages MGW resources (PSTN-to-IP and IP-to-IP conversion, transcoding, media processing, etc.) in a “master-slave” relationship with the MGW module 110.

The MGW module 110 is connected to the core IP network 124, to the MGCF module 108, and to the PSTN 126 or other network 128. It provides the interface between circuit-switched networks and IP networks, and/or functions as the gateway between the IMS network and other packet-based networks. Its primary role is transcoding media from one format to another (e.g., circuit-switched to packet, or from one type of IP codec to another), enabling an IMS terminal to make and receive calls and other communications with non-IMS terminals. The MGW module 110 is controlled by the MGCF module 108.

Further information about the MRFC module, MGCF module, and MGW module, in terms of how they function in the IMS network, can be found in the literature, and is known to those skilled in the art. As noted above, from the perspective of the IMS network, the MRFC module 106, MGCF module 108, and MGW module 110 are configured to duplicate or mimic the functionality of the MRFC, MGCF, and MGW in the IMS network, according to the particular protocols of the IMS network, as if they were provided as separate network nodes instead of integrated together in the control unit 104.

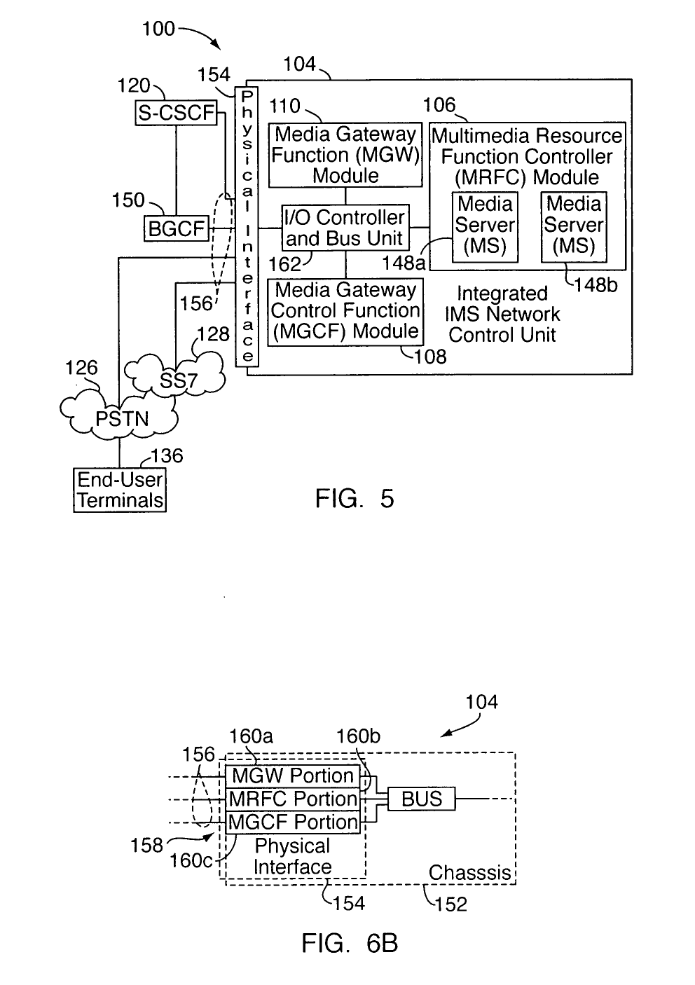

Typically, the integrated IMS network control unit 104 will include a chassis 152 (see FIG. 6A), which may take the form of a housing, cabinet, case, framework, or the like. The MRFC, MGCF, and MGW modules are housed together in the chassis 152, along with an external physical interface 154. The physical interface 154 is used for electrically and physically connecting the internal circuitry of the control unit 104 to one or more external data cables or other signal buses 156 of the IMS network 100, which are in turn directly or indirectly connected to the other network elements. The external physical interface 154 includes one or more electrical connectors, ports, plugs, or other terminals 158, which are electrically connected to the interior circuitry of the control unit 104. The external physical interface 154 conforms to a specification of the IMS network for MGCF, MRFC, and MGW physical interfaces, to the extent such interfaces are specified. (For example, if the IMS network uses multi-conductor cables for interconnecting network elements, there might be specifications relating to the number of pins for each cable connector, the function of each pin, and the expected voltage levels on the pins.) Otherwise, the external physical interface is configured to match whatever cables/buses are actually used in the IMS network for interconnecting the network elements in question. (This encompasses the physical interface including one or more cable converters.) In this manner, the control unit 104 is physically and electrically connected to the rest of the IMS network 100 in the same manner as if the MRFC, MGCF, and MGW modules were implemented as separate network nodes, meaning that the control unit is transparent to the IMS network bus architecture in terms of its integrated configuration.

In regards to integrating the MRFC module 106, MGW module 110, and MGCF module 108 together in the control unit 104, this may be done in several ways. In the simplest, as shown in FIG. 6A, the modules are provided as separate electronic units (e.g., plug-in cards) housed together in the chassis 152. The modules may share a common power source, and may be interconnected using external interfaces (e.g., the MGCF module 108 being connected to the MGW module 110 using connectors provided for this purpose), but are otherwise autonomous. Here, the physical interface 154 is divided into several sub-portions 160a-160c, which may be part of the same connector block but are at least logically discreet. Each sub-portion 160a-160c is dedicated for use with a particular one of the modules 106, 108, 110, with dedicated wiring or other signal pathways connecting the sub-portions to their respective modules.

In another embodiment, the modules 104, 106, 108 are further integrated together as relating to communicating with one another and/or with the external physical interface. As shown in FIGS. 5 and 6B, for example, the control unit 104 may include an internal bus 162 electrically connected to the external physical interface 154. The internal bus 162 interconnects the physical interface 154 to the various modules 106, 108, 110, and acts as a centralized communication pathway between the modules and the external physical interface 154. Alternatively or in addition, the bus 162 may be used for inter-module communications, such as between the MGCF module 108 and the MGW module 110. Typically, the bus 162 will include I/O controller functionality (e.g., a bus scheduler or controller) for governing communications over the bus. One of the functions of the I/O controller is to direct signals received at the external physical interface 154 to the modules for which they are intended. This may be done based on the content of the signals, or based upon where the signals arrive at the physical interface. For example, if signals arrive at an MGW portion 160a of the interface 154, the I/O controller function directs those signals over the bus to the MGW module 110. Such scheduling functions can be implemented using standard data network methods.

The MRFC module 106, MGW module 110, and MGCF module 108 may be further directly integrated within the integrated control unit 104. For example, the functionality of the modules may be implemented using a single electronics board/module that contains MRFC, MGW, and MGCF sub-sections, or in a distributed manner across several such boards/modules. Alternatively, assuming sufficient processing power is available, the modules may be implemented in software, in conjunction with one or more processors and related electronic equipment in either, the MRFC, MGW, and MGCF function will typically be logically discreet for interfacing with the IMS network. Additionally, the external physical interface 154 of the control unit 104 will conform to what is expected in the IMS work for separate-noted MRFC, MGW, and MGCF units.

Since certain changes may be made in the above-described IMS network architecture with consolidated network elements, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. An IP multimedia subsystem (IMS) network comprising:
a plurality of interconnected IMS network elements; and
an integrated IMS network control unit interfaced with said plurality of IMS network elements;
wherein the control unit is a single network node; and
wherein the control unit includes a multimedia resource function (MRF) module, a media gateway control function (MGCF) module, and a media gateway (MGW) module integrated into the single network node of the control unit.

2. The IMS network of claim 1, wherein the control unit further comprises:
a chassis housing said modules; and
an external physical interface connected to said chassis and operably connected to one or more of said modules for transferring electrical signals received from the plurality of network elements to the modules, wherein the external physical interface conforms to at least one specification of the IMS network for MGCF, MRF, and MGW physical interfaces if provided as separate nodes of an IMS network.

3. The IMS network of claim 2, wherein the control unit further comprises a bus unit interconnecting said modules for the exchange of data there between.

4. The IMS network of claim 2, wherein the control unit further comprises an input/output (I/O) controller interfaced with the external physical interface and/or said modules, said I/O controller being configured to direct data received at the external physical interface to said modules based on the content of said data and/or on where the data is received at the physical interface.

5. The IMS network of claim 4, wherein the control unit further comprises a bus unit interconnecting said modules for exchanging data there between, wherein the bus unit and I/O controller are an integral unit.

6. The IMS network of claim 1, wherein the control unit further comprises a bus unit interconnecting said modules for exchanging data there between.

7. The IMS network of claim 1, wherein the control unit further comprises an input/output (I/O) controller interfaced with the external physical interface and/or said modules, said I/O controller being configured to direct data received at the external physical interface to said modules based on the content of said data and/or on where the data is received at the physical interface.

8. The IMS network of claim 7, wherein the control unit further comprises a bus unit interconnecting said modules for exchanging data there between, wherein the bus unit and I/O controller comprise an integral unit.

9. The IMS network of claim 1, wherein the modules conform to at least one specification of the IMS network for MRF, MGCF, and MGW data processing functionality.

10. The IMS network of claim 9, wherein the control unit further comprises:
an external physical interface operably connected to one or more of said modules for transferring electrical signals received from the network elements to the modules, wherein the external physical interface conforms to at least one specification of the IMS network for MGCF, MRF, and MGW physical interfaces if provided as separate nodes of the IMS network.

11. The IMS network of claim 1, wherein the control unit further comprises:
an external physical interface operably connected to one or more of said modules for transferring electrical signals received from said plurality of network elements to said modules, wherein the external physical interface conforms to a specification of the IMS network for MGCF, MRF, and MGW physical interfaces if provided as separate nodes of the IMS network.

12. An integrated control unit for an IP multimedia subsystem (IMS) network, said control unit comprising:
a multimedia resource function (MRF) module, a media gateway control function (MGCF) module, and a media gateway (MGW) module, wherein the modules are integrated together in the control unit as a single network node of the IMS network; and
an external physical interface operably connected to said modules for transferring data received from one or more external IMS network elements to the modules.

13. The control unit of claim 12, wherein the modules conform to at least one specification of the IMS network for performing MRF, MGCF, and MGW data processing functions.

14. The control unit of claim 13, wherein the physical interface conforms to at least one specification of the IMS network for MGCF, MRF, and MGW physical interfaces.

15. The control unit of claim 14 further comprising a chassis that houses said modules and said external physical interface.

16. The control unit of claim 14 further comprising a bus unit interconnecting said modules for the exchange of data there between.

17. The control unit of claim 14 further comprising an input/output (I/O) controller interfaced with the external physical interface and/or said modules, said I/O controller being configured to direct data received at the external physical interface to said modules based on the content of said data and/or on where the data is received at the physical interface.

18. The control unit of claim 17 wherein the bus unit and I/O controller are an integral unit.

19. A method of exchanging data in an IP multimedia subsystem (IMS) network, said method comprising:
transferring data between a plurality of IMS network elements and a single node of the IMS network, said single node being interfaced with said plurality of IMS network elements for communicating there with;
wherein the single node includes a multimedia resource function (MRF) module, a media gateway control function (MGCF) module, and a media gateway (MGW) module, said modules being integrated together and conforming to at least one specification of the IMS network for performing MRF, MGCF, and MGW functions.

20. The method of claim 19 further comprising:
receiving said data at a physical interface of the node, said node comprising a chassis that houses said physical interface and said modules; and
directing said data to said modules based on the content of said data and/or on where the data is received at the physical interface.
